(19) United States
(12) Patent Application Publication
(10) Pub. No.: US 2012/0169695 A1
(43) Pub. Date: Jul. 5, 2012

(54) TIMING CONTROL CIRCUIT AND FLAT DISPLAY APPARATUS USING SAME

(75) Inventors: Chia-Wei Chang, Hsin-Chu (TW); Hsin-Yu Lin, Hsin-Chu (TW)

(73) Assignee: AU OPTRONICS CORP., Hsinchu (TW)

(21) Appl. No.: 13/192,793

(22) Filed: Jul. 28, 2011

(30) Foreign Application Priority Data
Dec. 29, 2010 (TW) 099146671

(51) Int. Cl. G09G 5/00

(52) U.S. Cl. 345/211

(57) ABSTRACT

A timing control circuit includes a gate voltage supply module, a control module and a gate voltage adjusting module. The gate voltage supplying module generates and outputs a gate voltage. The control module outputs at least one control signal following a variation of time during a period for displaying a frame of image. The gate voltage adjusting module is electrically connected both to the gate voltage supply module and the control module, and adjusts a change rate of an original gate voltage on a junction between the gate voltage adjusting module and the gate voltage supply module according to the at least one control signal. The change rate of the original gate voltage is gradually decreasing or increasing, and the gate voltage output is relative to the original gate voltage. A flat display apparatus using the timing control circuit is also provided.

### TECHNICAL FIELD

The disclosure relates to flat display apparatus, and more particularly to a timing control circuit and a flat display apparatus with an improved uniformity of display quality.

### BACKGROUND

With flat display technology, display quality of flat display apparatus is improved to satisfy consumers. Uniformity of a gate voltage provided to the thin film transistor is an important aspect which impacts display quality of the flat display apparatus very much.

FIG. 1 schematically illustrates a conventional flat display apparatus 100. The conventional flat display apparatus 100 includes a gate voltage supply circuit 110, a gate driving circuit 120, and a display panel 130. The display panel 130 includes a plurality of scanning lines GL₁˜GLₘ, a plurality of data lines DL₁˜DLₙ, and a plurality of pixel units P_{1,1}˜P_{m,n}. In order to clearly describe the relationships between the pixel units, the scanning lines and the data lines, a pixel unit P_{x,y} is defined as a pixel unit electrically connected both to a scanning line GLₓ and a data line DL_{y}, wherein 1≦x≦m, 1≦y≦n. For example, the pixel unit P_{1,1} is a pixel unit electrically connected both to a scanning line GL₁ and a data line DL₁, and so on. The gate voltage supply circuit 110 provides a gate voltage V1 to the gate driving circuit 120. The gate driving circuit 120 transforms the gate voltage V1 into pulse signal A, and sequentially transmits the pulse signals A to the scanning lines GL₁˜GLₘ. Thus, the gate driving circuit 120 controls the pixel units P_{x,1}˜P_{x,n} electrically coupled to the same scanning line GLₓ whether receive display data from corresponding data lines DL₁˜DLₙ or not. Therefore, the pulse signal A is relative to the gate voltage V1.

Since the distances respectively of transmitting the pulse signal A to the corresponding pixel units P_{x,1}˜P_{x,n} of the same scanning line GLₓ are different, a parasitic resistance and capacitor effect is generated. The pulse signal A may distort during transmission due to the impact of the parasitic resistance and capacitor effect. Therefore, each pixel unit P_{x,y} receives a different pulse signal A due to the different distances of transmitting the pulse signal A, and thus the display quality becomes worse. A chamfer is formed at a falling edge of the pulse signal A to resolve the foresaid problem. However, this method can only decrease the distortion of the pulse signals transmitted to the pixel units _{P}_{x,1}˜P_{x,n} of the same scanning line GLₓ, which decreases the distortions in a horizontal direction. In fact, the pulse signal A received by the scanning lines GL₁˜GLₘ from the gate driving circuit 120 also distort due to the different distances of transmitting the pulse signal A, which causes distortions in a vertical direction. The foresaid method cannot resolve the problem of distortion in the vertical direction. Thus, the display quality in the vertical direction is not uniform.

### SUMMARY

An exemplary timing control circuit for flat display apparatus is provided in the disclosure. The timing control circuit includes a gate voltage supply module, a control module and a gate voltage adjusting module. The gate voltage supplying module generates and outputs a gate voltage. The control module outputs at least one control signal following a variation of time during a period for displaying a frame of image. The gate voltage adjusting module is electrically connected both to the gate voltage supply module and the control module, and adjusts a change rate of an original gate voltage on a junction between the gate voltage adjusting module and the gate voltage supply module according to the at least one control signal output by the control module. The change rate of the original gate voltage is gradually decreasing or increasing, and the gate voltage output by the gate voltage supply module is relative to the original gate voltage.

In another embodiment, an exemplary flat display apparatus is provided. The flat display apparatus includes a plurality of data lines for providing display data, a plurality of scanning lines arranged in a first direction and configured for transmitting a pulse signal, and a plurality of pixel units respectively connected to corresponding data lines and corresponding scanning lines. Each pulse signal transmitted in the corresponding scanning line has a chamfer at a falling edge, and slope variations of the chamfers along with the first direction are same.

### BRIEF DESCRIPTION OF THE DRAWINGS

The present invention will become more readily apparent to those ordinarily skilled in the art after reviewing the following detailed description and accompanying drawings, in which:

FIG. 1 is a schematic circuit block diagram of a conventional flat display apparatus;

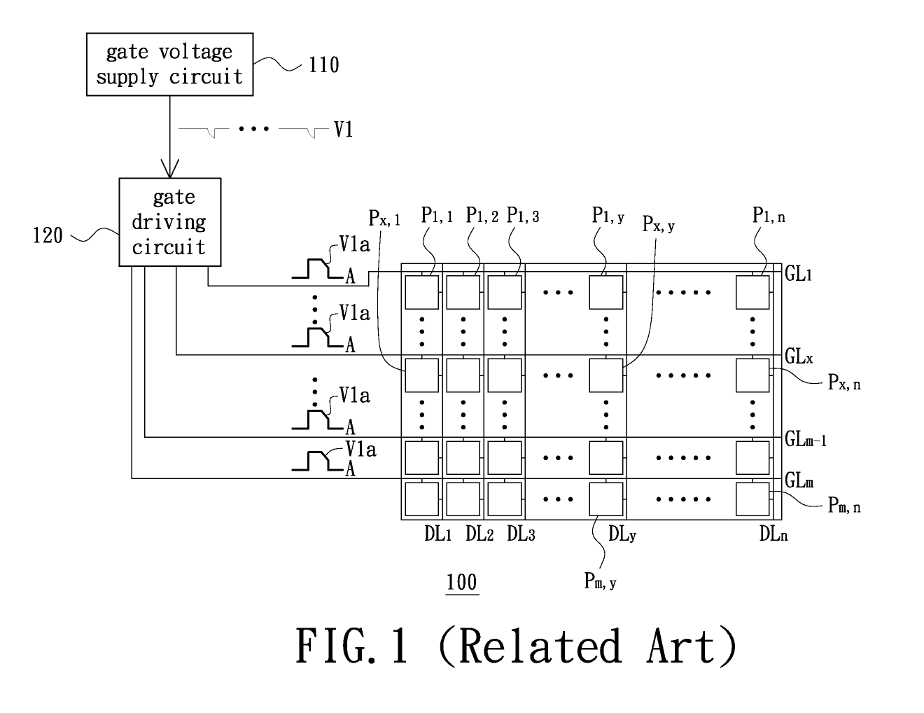

FIG. 2 is a schematic circuit block diagram of an exemplary flat display apparatus;

FIG. 3 is a schematic circuit block diagram of a timing control circuit and a gate driving circuit of the flat display apparatus of FIG. 2;

FIG. 4 is a timing signal diagram employed by the exemplary flat display apparatus;

FIG. 5 is a timing signal diagram employed by a second exemplary flat display apparatus; and

FIG. 6 is a timing signal diagram employed by a third exemplary flat display apparatus.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

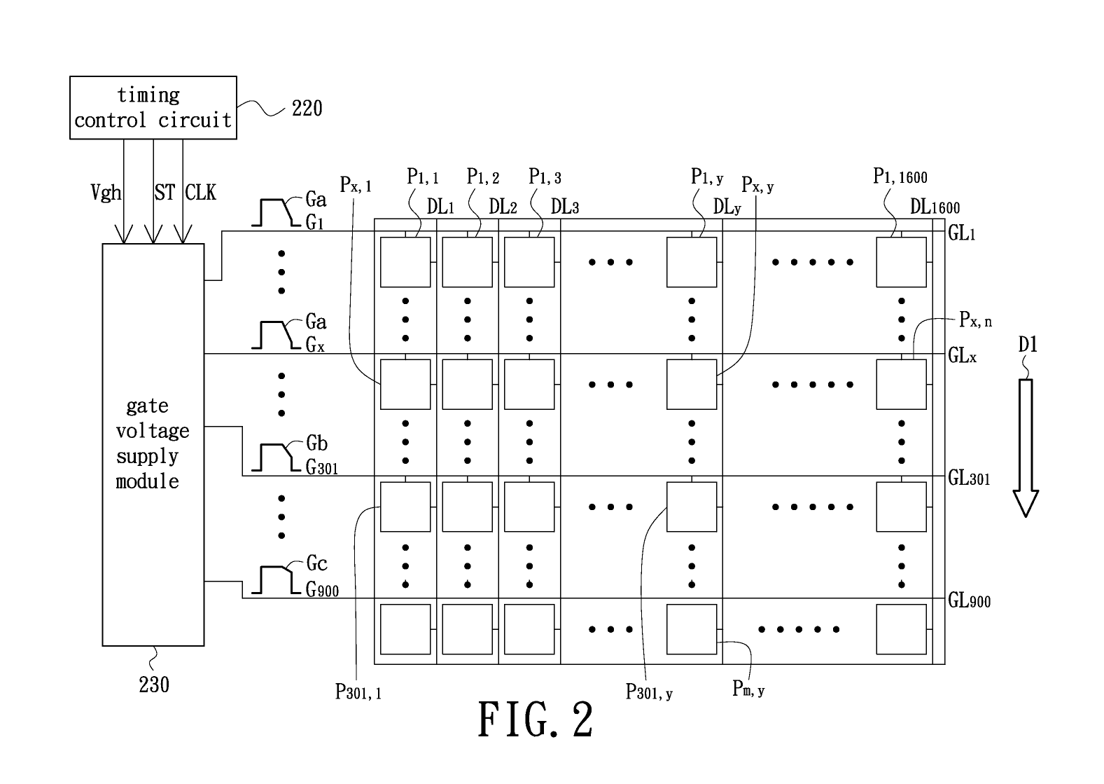

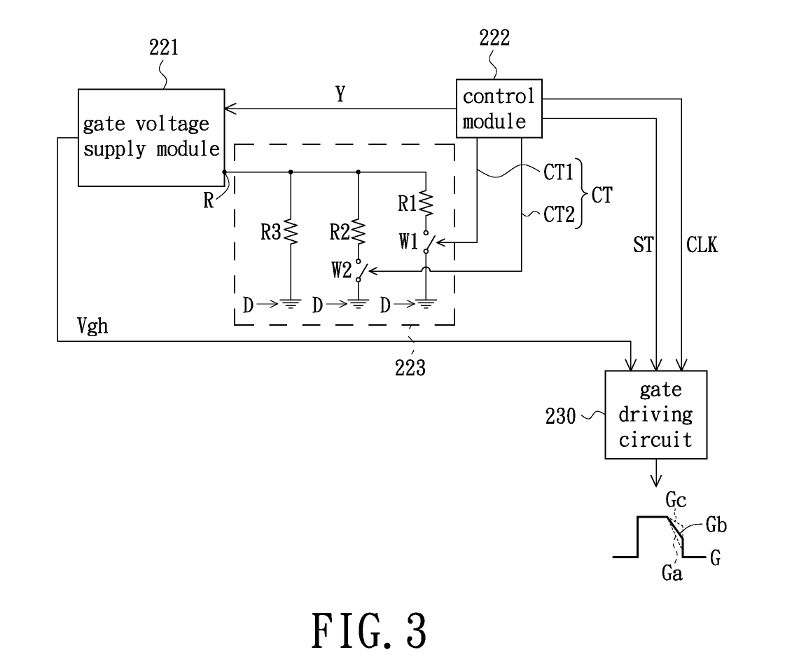

FIG. 2 schematically shows an exemplary flat display apparatus 200. FIG. 3 is a schematic view of a timing control circuit 220 and a gate driving circuit 230 of the flat display apparatus 200 of FIG. 2. Referring FIG. 2, the flat display apparatus 200 includes a display panel 210. The display panel 210 has a plurality scanning lines GL₁˜GLₘ, a plurality of data lines DL₁˜DLₙ, and a plurality of pixel units P_{1,1}˜P_{m,n}. In the exemplary embodiment, the display panel 210 has 900*1600 pixel units, 900 scanning lines GL₁˜GL₉₀₀, and 1600 data lines DL₁˜DL₁₆₀₀. In order to clearly describe the relationships between the pixel units, the scanning lines and the data lines, a pixel unit P_{x,y} is defined as a pixel unit electrically connected both to a scanning line GLₓ and a data line DL_{y}, wherein 1≦x≦900, 1≦y≦1600. For example, the pixel unit P_{1,2} is a pixel unit electrically connected both to a scanning line GL₁ and a data line DL₂, and so on. The data lines DL₁˜DL₁₆₀₀ provide display data for the flat display apparatus 200. The scanning lines GL₁˜GL₉₀₀ are paralleled arranged along a first direction D1, and are used to transmit pulse signals G₁˜G₉₀₀. Each pulse signal G₁˜GL₉₀₀ respectively transmitted by a corresponding scanning line GL₁˜GL₉₀₀ has a chamfer Ga/Gb/Gc at a falling edge. Slope variations of the chamfers Ga/Gb/Gc are the same, e.g. gradually decreasing or gradually increasing, along with the first direction D1.

The timing control circuit 220 of the flat display apparatus 200 makes the slopes of the chamfers Ga/Gb/Gc variable. Referring to FIGS. 2 and 3 together, the timing control circuit 220 includes a gate voltage supply module 221, a control module 222, and a gate voltage adjusting module 223. The gate voltage supply module 221 provides a gate voltage Vgh. The control module 222 outputs at least one control signal CT following a variation of time during a period for displaying a frame of image. The gate voltage adjusting module 223 is electrically connected both to the control module 222 and the gate voltage supply module 221. The gate voltage adjusting module 223 determines a changing rate of the original gate voltage, i.e. the voltage of node R, depending on the control signal CT output by the control module 222. The changing rate of the original gate voltage is gradually decreasing or gradually increasing following the variation of time. The gate voltage Vgh is relative to the original gate voltage, and is corresponding to a threshold of the pulse signals G₁˜G₉₀₀.

The gate voltage adjusting module 223 includes a plurality of resistors parallel connected, and a plurality switches. In the exemplary embodiment, the gate voltage adjusting module 223 includes threes resistors, i.e. a first resistor R1, a second resistor R2, and a third resistor R3, and two switches, i.e. a first switch W1 and a second switch w2. The first, second and third resistors R1, R2, R3 each has a terminal electrically connected to the original voltage, and the third resistor R3 is further electrically connected between the original gate voltage and a predetermined potential D. The first switch W1 is electrically connected between another terminal of the first resistor R1 and the predetermined potential D. The second switch W2 is electrically connected between another terminal of the second resistor R2 and the predetermined potential D.

The control signal CT output by the control module 222 actuates the first and second switches W1, W2 whether turn on or not. In the exemplary embodiment, the control signal CT includes two secondary control signals CT1, CT2. The original gate voltage discharges via different discharging route according to the first and second switches W1, W2 which is turned on, thereby driving the original gate voltage decrease or increase gradually.

Referring to FIGS. 2, 3 and 4 together, the control module 222 provides a starting signal ST to the gate driving circuit 230 to actuate the gate driving circuit 230. The control module 222 further provides a time control signal Y to the gate voltage supply module 221 to determine a discharge duration time t of the original gate voltage. In addition, the secondary control signals CT1, CT2 output by the control module 222 respectively enable the first and second switches W1, W2 to turn on or turn off, thus the original gate voltage discharges according to a corresponding discharging route to gradually decrease the original gate voltage. Moreover, the control module 222 provides a clock signal CLK to the gate driving circuit 230, so the gate driving circuit 230 sequentially transmits the pulse signals G₁˜G₉₀₀ to the scanning lines GL₁˜GL₉₀₀.

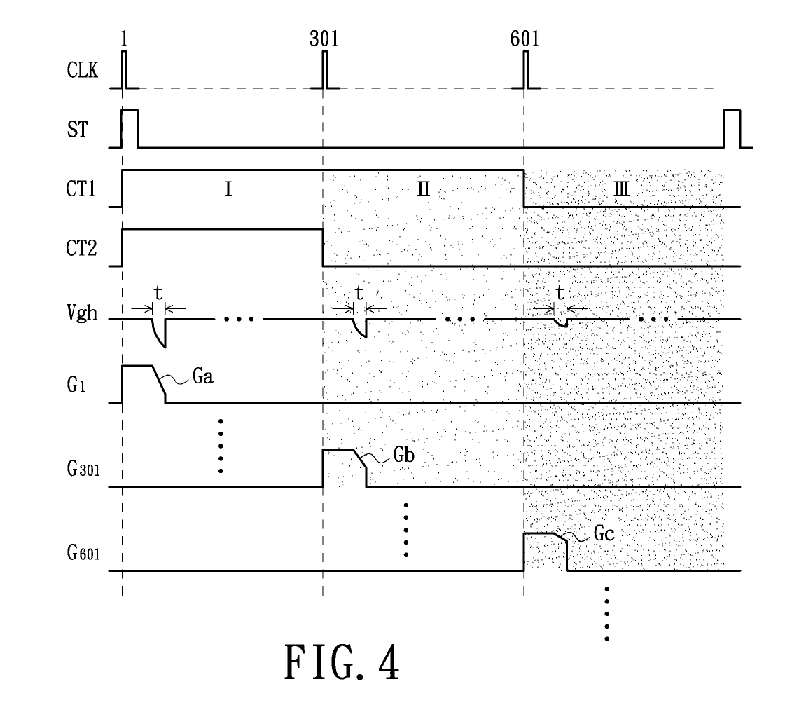

The secondary control signals CT1, CT2 both change following the variation of time during the period for displaying a frame of image, so the voltage drops of the original gate voltage are different according to the actuation of the first switch W1 or the second switch W2. In the exemplary embodiment, the secondary control signals CT1, CT2 respectively change three times during the period for displaying a frame of image. A duration time that the clock signal CLK controls the scanning lines GL₁˜GL₃₀₀ is defined as a first duration time I, a duration time that the clock signal CLK controls the scanning lines GL₃₀₁˜GL₆₀₀ is defined as a second duration time II, and a duration time that the clock signal CLK controls the scanning lines GL₆₀₁˜GL₉₀₀ is defined as a third duration time III. During the first duration time I, the secondary control signals CT1, CT2 both are high level voltage signals which cause both of the first and second switches W1, W2 to actuate. In the meantime, the first and second resistors R1, R2 are actuated, and are paralleled connected with the third resistor R3, and such that a discharging duration time of the original gate voltage is determined cooperatively with the timing control signal Y. Hence, during the first duration time I, the gate voltage supply module 221 transforms the original gate voltage to the gate voltage Vgh shown in FIG. 4. The gate driving circuit 230 sequentially generates the pulse signals G₁˜G₃₀₀ according to the gate voltage Vgh and the clock signal CLK, and transmits the pulse signals G₁˜G₃₀₀ respectively to the corresponding one of the scanning lines GL₁˜GL₃₀₀. Therefore, the pulse signal G₁ received by the scanning line GL₁ has a corresponding chamfer Ga at the falling edge as shown in FIG. 4.

Next, during the second duration time II, the secondary control signal CT1 is still high level voltage signal and the secondary control signal CT2 changes to low level voltage signal, so the first switch W1 is actuated and the second switch W2 is break. Accordingly, the first resistor R1 is actuated and paralleled connected with the third resistor R3, and a discharge amount of the original gate voltage is decreasing during the discharge duration time t. Therefore, as shown in FIG. 4, when the clock signal CLK respectively controls the scanning lines GL₃₀₁˜GL₆₀₀, the gate voltage Vgh transmitted to the gate driving circuit 230 during the second duration time II has a slow discharge rate. Then, the clock signal CLK respectively controls the scanning lines GL₆₀₁˜GL₉₀₀, and the first and second switches W1, W2 both change to break. The discharge amount of the original gate voltage during the discharge duration time t accordingly changes, which causes that the slope of the chamfer Gc of the scanning line G₆₀₁ is smaller than that of the chamfer Gb of the scanning line G₃₀₁.

The gate driving circuit 230 sequentially transmits the pulse signals G₁˜G₉₀₀ to the scanning lines GL₁˜GL₉₀₀ according to the clock signal CLK provided by the control module 222, and thus controls the pixel units P_{x,1}˜P_{x,1600} connected to the same scanning line GLₓ whether receive image data from corresponding data lines DL₁˜DL₁₆₀₀ or not, wherein x≦900. Since the gate driving circuit 230 adjusts the pulse signals G₁˜G₉₀₀ according to the gate voltage Vgh, the pulse signals G₁˜G₉₀₀ is relative to the gate voltage Vgh. The gate voltage supply module 221 generates the gate voltage Vgh following the variation of time, as shown in FIG. 4, and voltage variation thereof is following the variation of time during the discharge duration time t. Therefore, the chamfers Ga/Gb/Gc respectively of the pulse signals G₁˜G₉₀₀ input to different scanning lines GL₁˜GL₉₀₀ are following the voltage variation of the gate voltage Vgh. In other words, when the gate driving circuit 230 sequentially provides the pulse signals G₁˜G₉₀₀ respectively to different scanning lines GL₁˜GL₉₀₀, the change rate of the original gate voltage can be adjusted and cause the slopes respectively of the chamfers of the pulse signals G₁˜G₉₀₀ different according to different distances for transmitting the pulse signals G₁˜G₉₀₀, and thus decrease the impact of parasitic resistance and capacitor effect generated by different distances for transmitting the pulse signals G₁˜G₉₀₀.

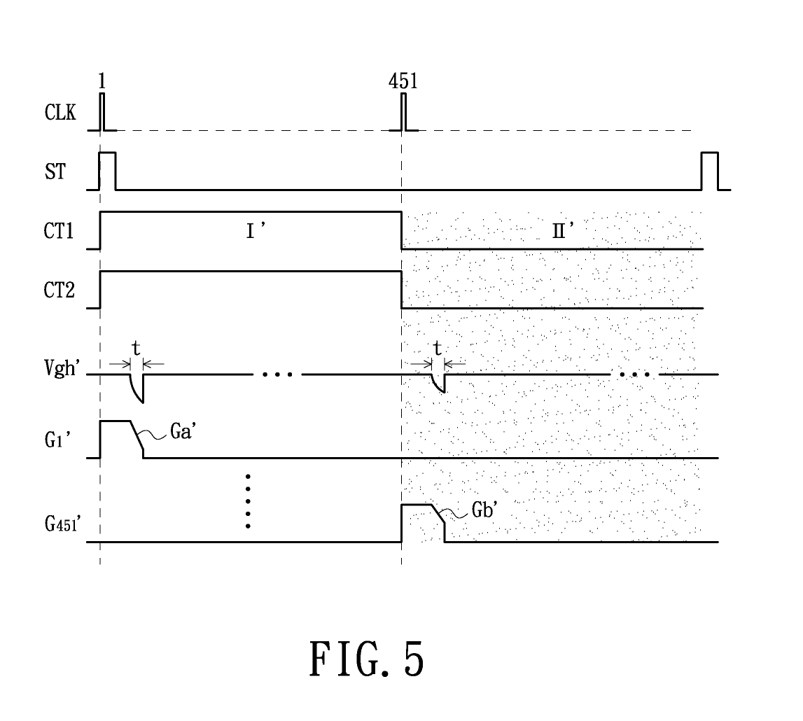

It is to be noted that, the variation times of the control signal CT can be changed to meet the design requirement. Referring to FIGS. 3 and 5, in a second exemplary embodiment, the secondary control signals CT1, CT2 change once during the period for displaying a frame of image, thus the falling edge of the pulse signals G₁˜G₉₀₀ input to the scanning lines GL₁˜GL₉₀₀ has two different chamfer slopes.

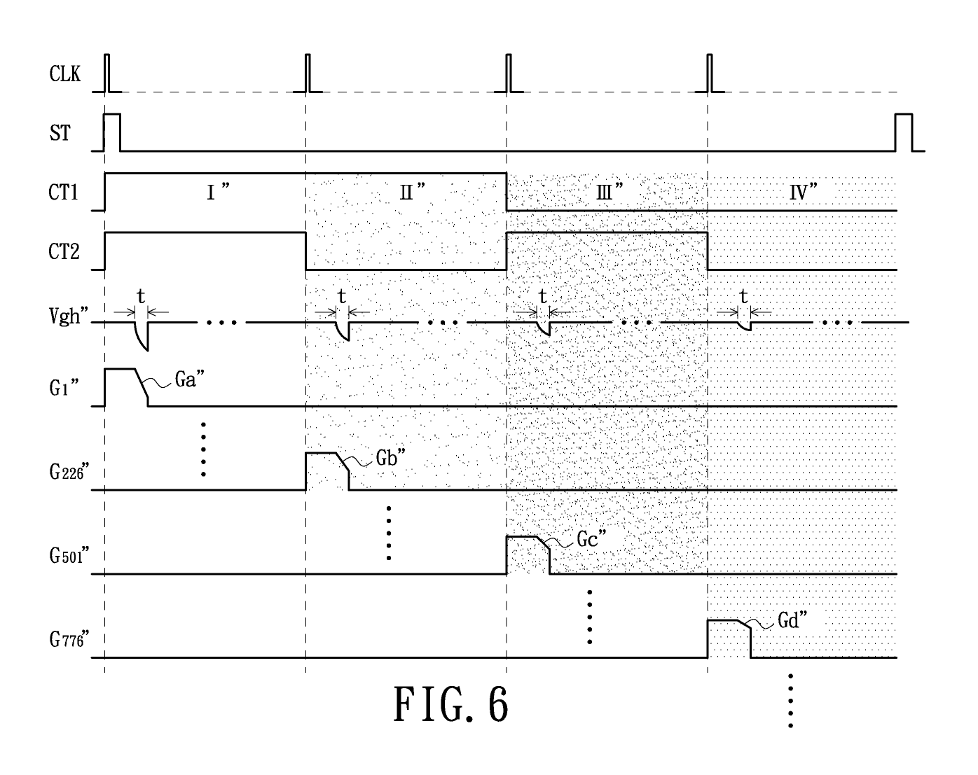

In addition, the resistances respectively of the resistors also can be changed according to the design requirement, which cooperatively with the changes of the secondary control signals CT1, CT2, can change the chamfer slopes of the pulse signals to meet the design requirement. Referring to FIGS. 3 and 6, in a third exemplary embodiment, the resistance of the first resistor is smaller than that of the second resistor, and the secondary control signals CT1, CT2 both change three times. By selectively switching on or off the first and second switches W1, W2 respectively electrically coupling to the first and second resistors R1, R2, the chamfers of the pulse signals G₁″˜G₂₂₅″, G₂₂₆″˜G₅₀₀″, G₅₀₁″˜G₇₇₅″, G₇₇₆″˜G₉₀₀″ can reach to Ga″, Gb″, Gc″, Gd″, so as to decrease the differences of the pulse signal received by each pixel unit due to different distances for transmitting the pulse signal and thus improve the display quality.

It is to be understood that, the gate voltage adjusting module 223 can but not limited to include a plurality of resistors parallel connected and a plurality of switches respectively connected to the corresponding resistors in series, as in the exemplary embodiment. An essential aspect of the present invention is that the chamfer slope of the pulse signal changes following the variation of the resistance of the resistor. Therefore, a variable resistor can be electrically connected between the original gate voltage and the predetermined potential D, and the resistance of the variable resistor can be changed according to the control signal CT output by the control module 222. Additionally, the voltage level of the secondary control signals CT1, CT2 and the chamfer slopes of the pulse signals relative to the secondary control signals CT1, CT2 both can but not limited to change during equally duration time to equally divide the display image, as in the exemplary embodiment.

In the exemplary flat display apparatus, the gate voltage adjusting module adjusts the change rate of the original gate voltage according to the control signals output by the control circuit, and thus when the gate voltage is transmitted to different scanning lines, the impact of parasitic resistance and capacitor effect generated by different distances for transmitting the pulse signals is decreased. Therefore, the flat display apparatus can improve display quality by improving the uniformity of the gate voltage in a vertical direction.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A timing control circuit for flat display apparatus, comprising:
a gate voltage supply module generating and outputting a gate voltage;
a control module outputting at least one control signal following a variation of time during a period for displaying a frame of image; and
a gate voltage adjusting module electrically connected both to the gate voltage supply module and the control module, configured for adjusting a change rate of an original gate voltage on a junction between the gate voltage adjusting module and the gate voltage supply module according to the at least one control signal output by the control module;
wherein the change rate of the original gate voltage is gradually decreasing or increasing, and the gate voltage output by the gate voltage supply module is relative to the original gate voltage.

2. The timing control circuit according to claim 1, wherein the gate voltage adjusting module comprising:
a plurality of resistors parallel connected and each having a terminal electrically coupled to the original gate voltage; and
a plurality of switches respectively electrically coupled between the corresponding resistors and a predetermined potential;
wherein when one of the switches is actuated, a corresponding discharging route for the original gate voltage is provided such that the original gate voltage decreases gradually.

3. The timing control circuit according to claim 1, wherein the gate voltage adjusting module comprising:
a first resistor and a second resistor each having a terminal electrically coupled to the original gate voltage;
a third resistor electrically coupled between the original gate voltage and a predetermined potential;
a first switch electrically coupled between another terminal of the first resistor and the predetermined potential; and
a second switch electrically coupled between another terminal of the second resistor and the predetermined potential;
wherein the at least one control signal output by the control module controls whether actuates the first switch and the second switch.

4. The timing control circuit according to claim 1, wherein the gate voltage adjusting module comprising:
a variable resistor coupled between the original gate voltage and a predetermined potential, and a resistance of the variable resistor being variable according to the at least one control signal output by the control module.

5. A flat display apparatus, comprising:
a plurality of data lines providing display data;
a plurality of scanning lines arranged in a first direction and each configured for transmitting a pulse signal; and
a plurality of pixel units respectively electrically connected to corresponding one of the data lines and corresponding one of the scanning lines;
wherein each pulse signal transmitted in the corresponding scanning line having a chamfer at a falling edge, and slope variations of the chamfers along with the first direction being the same.

6. The flat display apparatus according claim 5 further comprising a timing control circuit comprising:
a gate voltage supply module generating and outputting a gate voltage;
a control module outputting at least one control signal following a variation of time during a period for displaying the frame of image; and
a gate voltage adjusting module electrically connected both to the gate voltage supply module and the control module, configured for adjusting a change rate of an original gate voltage on a junction between the gate voltage adjusting module and the gate voltage supply module according to the at least one control signal output by the control module;
wherein the gate voltage corresponds to a threshold of the pulse signal.

7. The flat display apparatus according to claim 6, wherein the gate voltage adjusting module comprising:
a plurality of resistors parallel connected and each having a terminal electrically coupled to the original gate voltage; and
a plurality of switches respectively electrically coupled between the corresponding resistors and a predetermined potential;
wherein when one of the switches is actuated, a corresponding discharging route for the original gate voltage is provided such that the original gate voltage decreases gradually.

8. The flat display apparatus according to claim 6, wherein the gate voltage adjusting module comprises:
a first resistor and a second resistor each having a terminal electrically coupled to the original gate voltage;
a third resistor electrically coupled between the original gate voltage and a predetermined potential;
a first switch electrically coupled between another terminal of the first resistor and the predetermined potential; and
a second switch electrically coupled between another terminal of the second resistor and the predetermined potential;
wherein the at least one control signal output by the control module controls whether actuates the first switch and the second switch.

9. The flat display apparatus according to claim 6, wherein the gate voltage adjusting module comprise a variable resistor electrically coupled between the original gate voltage and a predetermined potential, and a resistance of the variable resistor being variable according to the at least one control signal output by the control module.
